(19) United States
(12) Patent Application Publication
(10) Pub. No.: US 2026/0258635 A1
(43) Pub. Date: Sep. 3, 2026

(54) EXCAVATOR THROTTLE CONTROL DEVICE AND METHOD

(71) Applicant: Xuzhou XCMG Excavator Machinery Co., Ltd., Jiangsu (CN)

(72) Inventors: Yadong LI, Jiangsu (CN); Jiawen GENG, Jiangsu (CN); Yuzhong DONG, Jiangsu (CN); Yang LIU, Jiangsu (CN); Meng WEN, Jiangsu (CN); Feifei ZHAO, Jiangsu (CN); Yuhang ZHU, Jiangsu (CN); Zhao YU, Jiangsu (CN); Bingjie ZHOU, Jiangsu (CN); Yang ZHANG, Jiangsu (CN); Dongyang DU, Jiangsu (CN)

(73) Assignee: Xuzhou XCMG Excavator Machinery Co., Ltd., Jiangsu (CN)

(21) Appl. No.: 18/863,651

(22) PCT Filed: Sep. 30, 2022
(86) PCT No.: PCT/CN2022/122992

§ 371 Date: Nov. 7, 2024

(30) Foreign Application Priority Data
May 25, 2022 (CN) 202210572393.8

(51) Int. Cl. E02F 9/20; E02F 9/26; F02D 41/02; F16H 59/04; F16H 59/08; F16H 59/36; F16H 61/02

(52) U.S. Cl. CPC E02F 9/2066; E02F 9/2004; E02F 9/2079; F02D 41/0225; F16H 59/04; F16H 59/08; F16H 61/0213; E02F 9/26; F02D 2200/60; F16H 2059/081; F16H 2059/366; F16H 2061/0244

(57) ABSTRACT

The invention discloses an excavator throttle control device and method. The device comprises a main controller, an engine control module (ECM), an electronic monitor, a starting unit, a power supply relay and an integrated switch panel. The integrated switch panel effectively integrates a power switch and a throttle knob, and is used to control a throttle gear through operational switches and transmit a control instruction to the main controller. The main controller is used to determine an engine speed according to the gear control instruction sent by the integrated switch panel and send the same to the ECM. The ECM is used to control an engine to execute a corresponding speed for a specific gear.

### TECHNICAL FIELD

The invention relates to an excavator throttle control device and method, belonging to the technical field of electric control of excavators.

### TECHNICAL BACKGROUND

At present, the predominant way to control a throttle in excavators is by adjusting a throttle knob to regulate the speed. Typically, the throttle knob is a multi-gear device based on conventional potentiometers. Such devices are prone to gear-skipping due to the reduction in fatigue life of their mechanical gears, leading to poor control stability. The multi-gear mechanical adjustment method cannot be flexibly configured according to diverse operational needs, resulting in limited intelligent control capabilities. With the development of intelligent technology in excavators, traditional electrical systems can no longer adequately meet the diverse needs for intelligent operations.

### SUMMARY OF THE INVENTION

The purpose of the invention is to provide an excavator throttle control device and method, which effectively integrate a power switch and a throttle knob, thereby facilitating intelligent control of an engine throttle of an excavator.

To achieve the above objective, the invention adopts the following technical scheme:

An excavator throttle control device provided by the invention comprises a main controller, an engine control module (ECM), an electronic monitor, a starting unit, a power supply relay and an integrated switch panel;
wherein the main controller and the ECM are interconnected through a bus, the electronic monitor and the main controller are connected through a bus, the power supply relay is electrically connected with the integrated switch panel, and the starting unit is electrically connected with the main controller;
the main controller is used to determine an engine speed according to a gear control instruction sent by the integrated switch panel and send the same to the ECM, and acquire a speed for each gear through the electronic monitor;
the ECM is used to control an engine to execute a corresponding speed;
the electronic monitor records and sets throttle gears, comprising a highest gear, a lowest gear and a target gear;
the starting unit is used to control the startup of an excavator system;
the power supply relay is used to power on the excavator engine; and
the integrated switch panel is used to control the throttle gear through operational switches and transmit the control instruction to the main controller.

Further, the integrated switch panel at least comprises a switch control unit and three operational switches: a button, a knob, and a one-touch start switch, and the main controller is connected with the switch control unit;
the button is used to control throttle modes, comprising a long press mode, a double-click mode and a single-click mode;
the knob is used to control the power supply and reset of the excavator engine;
the one-touch start switch is used to control the excavator engine to start; and
the switch control unit is used to transmit control signals of each operational switch to the main controller.

Further,
in the long press mode, the switch control unit sends an instruction for executing the preset target gear to the main controller; and
in the double-click mode, the switch control unit sends an instruction for executing the lowest gear to the main controller; and
in the single-click mode, the switch control unit sends a gear switching instruction to the main controller, alternating between upshifting and downshifting with each press.

Further, the knob has an initial gear, a first gear and a second gear;
in the initial gear, the engine is in a reset state and is not powered on;

In the first gear, the power supply relay is powered to engage to control the excavator engine to be powered on;
the second gear is used to change the throttle gear,
in the single-click mode of the button, each press of the knob changes the gear state; if the current single-click mode is for upshifting, the switch control unit sends an instruction for increasing the gear by one to the main controller; and if the current single-click mode is for downshifting, the switch control unit sends an instruction for decreasing the gear by one to the main controller.

Further, the integrated switch panel further integrates a knob initial gear indicator light, a knob first gear indicator light and a knob second gear indicator light to indicate a current gear of the knob.

Further, the integrated switch panel at least comprises a switch control unit and three operational switches: a button, a knob, and a one-touch start switch, and the main controller is connected with the switch control unit;
the button is used to control throttle modes, comprising a long press mode and a double-click mode;
the knob is used to control throttle gears, comprising throttle increase and throttle decrease;
the one-touch start switch is used to control the excavator engine to be powered on, started and shut down; and
the switch control unit is used to transmit control instructions of each operational switch to the main controller.

Further,
in the long press mode, the switch control unit sends an instruction for executing the preset target gear to the main controller; and
in the double-click mode, the switch control unit sends an instruction for executing the lowest gear to the main controller.

Further, a middle position of the knob is an initial gear, with clockwise rotation for throttle increase and counterclockwise rotation for throttle decrease, and both gears feature a reset function;
the knob has contact modes, comprising a short contact mode and a long contact mode;
in the short contact mode, when in a throttle increase mode, each contact causes the switch control unit to send an instruction for increasing the gear by one to the main controller; when in a throttle decrease mode, each contact causes the switch control unit to send an instruction for decreasing the gear by one to the main controller;
in the long contact mode, when in the throttle increase mode, a long contact causes the switch control unit to send an instruction for executing the highest gear to the main controller; when in the throttle decrease mode, a long contact causes the switch control unit to send an instruction for executing the lowest gear to the main controller;
if contact time is less than a preset duration, it is deemed a short contact; and if the contact time is greater than the preset duration, it is considered a long contact.

Further, the one-touch start switch has a single-click mode and a long press mode;
in the single-click mode, each press results in the engine being powered on, started, and shut down in sequence; and
in the long press mode, the engine is powered off and shut down with a delay.

Further, the button is an electronic switch button or a touch screen button.

Further, the electronic monitor is specifically used to,
determine whether to enable gear memory, if the gear memory is enabled, the engine starts at the lowest gear speed and reaches a last remembered speed;
and,
set the target gear, the lowest gear, the highest gear and a single-click gear.

The invention further provides an excavator throttle control method, comprising:
turning the knob on the integrated switch panel in the excavator throttle control device mentioned above to the first gear, so that the power supply relay is powered to engage to control the engine to be powered on; controlling the engine to start through the one-touch start switch on the integrated switch panel;
determining whether poweroff gear memory is enabled, and if so, controlling the ECM through the main controller to make the engine execute a last gear speed prior to poweroff;
if the poweroff gear memory is not enabled, checking the mode of the button on the integrated switch panel,
in response to the long press mode, controlling the ECM through the main controller to make the engine execute a preset target gear speed;
in response to the double-click mode, controlling the ECM through the main controller to make the engine execute a preset lowest gear speed;
in response to the single-click mode, determining, through the main controller, whether to upshift or downshift; at the same time, changing the gear state with each press of the knob, that is, in the upshift mode, the gears increase progressively, and in the downshift mode, the gears decrease progressively; and determining, through the main controller, the changed gear and the corresponding speed, and controlling the ECM to make the engine execute the corresponding gear speed.

The invention further provides an excavator throttle control method, comprising:
pressing the one-touch start switch on the integrated switch panel in the excavator throttle control device mentioned above, so that the power supply relay is powered to engage to control the engine to be powered on; pressing the one-touch start switch again to start the engine;
determining whether poweroff gear memory is enabled, and if so, controlling the ECM through the main controller to make the engine execute a last gear speed prior to poweroff;
if the poweroff gear memory is not enabled, checking the mode of the button on the integrated switch panel,
in response to the long press mode, controlling the ECM through the main controller to make the engine execute a preset target gear speed;
in response to the double-click mode, controlling the ECM through the main controller to make the engine execute a preset lowest gear speed;
checking the gear state of the knob on the integrated switch panel,
in response to the throttle increase mode, determining the contact mode; in response to a short contact, sending an instruction for increasing the gear to the main controller, allowing the main controller to determine a new gear and a corresponding speed, and sending an instruction for executing the corresponding speed to the ECM to make the engine execute the corresponding speed; in response to a long contact, sending an instruction for adjusting to the highest gear to the main controller, allowing the main controller to determine a speed corresponding to the instruction, and sending an instruction for executing the corresponding speed to the ECM to make the engine execute the highest speed.
in response to the throttle decrease mode, determining the contact mode; in response to a short contact, sending an instruction for decreasing the gear to the main controller, allowing the main controller to determine a new gear and a corresponding speed, and sending an instruction for executing the corresponding speed to the ECM to make the engine execute the corresponding speed; in response to a long contact, sending an instruction for adjusting to the lowest gear to the main controller, allowing the main controller to determine a speed corresponding to the instruction, and sending an instruction for executing the corresponding speed to the ECM to make the engine execute the lowest speed;
if contact time is less than a preset duration, it is deemed a short contact; and if the contact time is greater than the preset duration, it is considered a long contact.

The invention has the following beneficial effects:

The invention effectively integrates a power switch and a throttle knob to achieve intelligent control of an excavator engine throttle, simplify the structure of the throttle knob and enhance its reliability. Further, the invention utilizes intelligent throttle control and a composite key function to achieve switching between throttle increase and decrease modes, as well as quick throttle control, enhancing the level of intelligence. The use of a resettable increase/decrease knob gear minimizes reliability issues caused by multiple gears and improves operability.

### DESCRIPTION OF THE DRAWINGS

FIG. 1 is a block diagram of an excavator throttle control system according to Embodiment 1 of the invention;

FIG. 2 is a structural diagram of an integrated switch panel in Embodiment 1 of the invention;

FIG. 3 is a flowchart of an excavator throttle control method according to Embodiment 2 of the invention;

FIG. 4 is a structural diagram of an integrated switch panel in Embodiment 3 of the invention; and

FIG. 5 is a flowchart of an excavator throttle control method according to Embodiment 4 of the invention.

### DETAILED DESCRIPTION OF THE EMBODIMENTS

The invention will be further described below. The following embodiments are only used to illustrate the technical scheme of the invention more clearly, but cannot be used to limit the protection scope of the invention.

### Embodiment 1

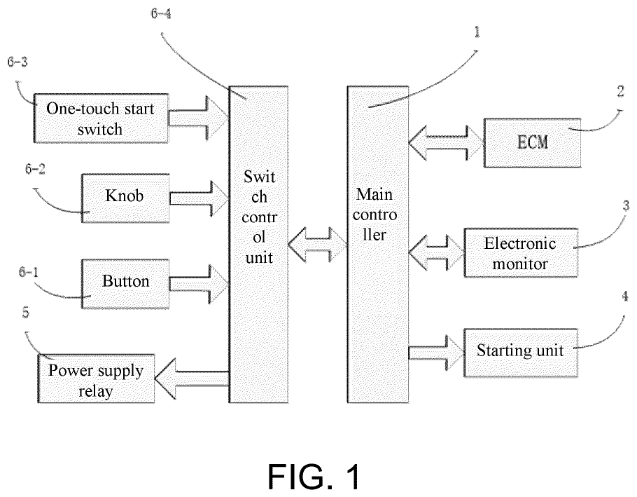

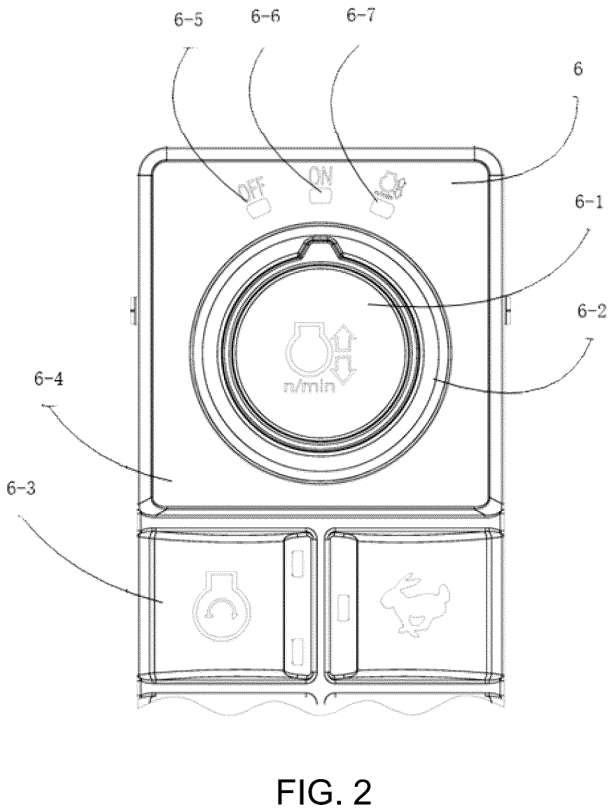

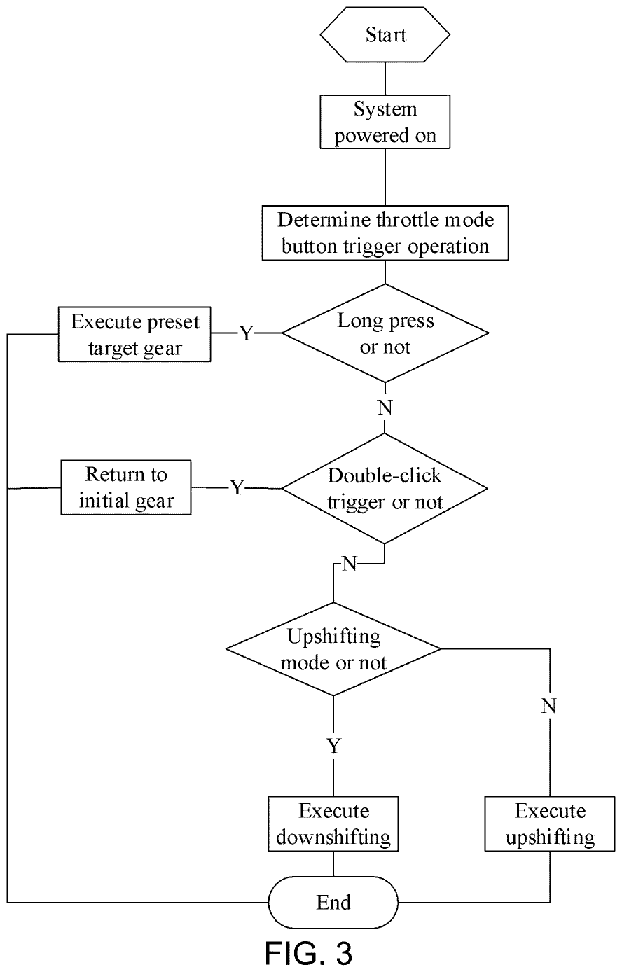

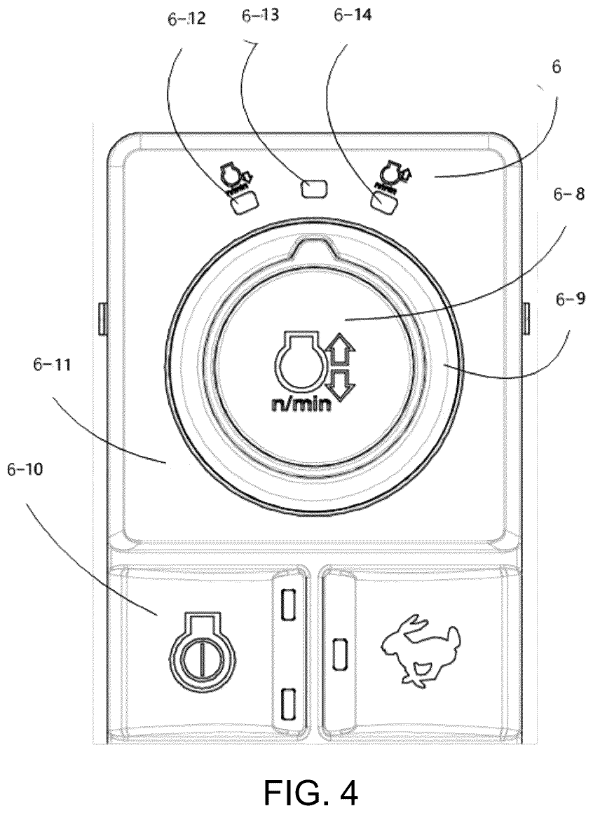

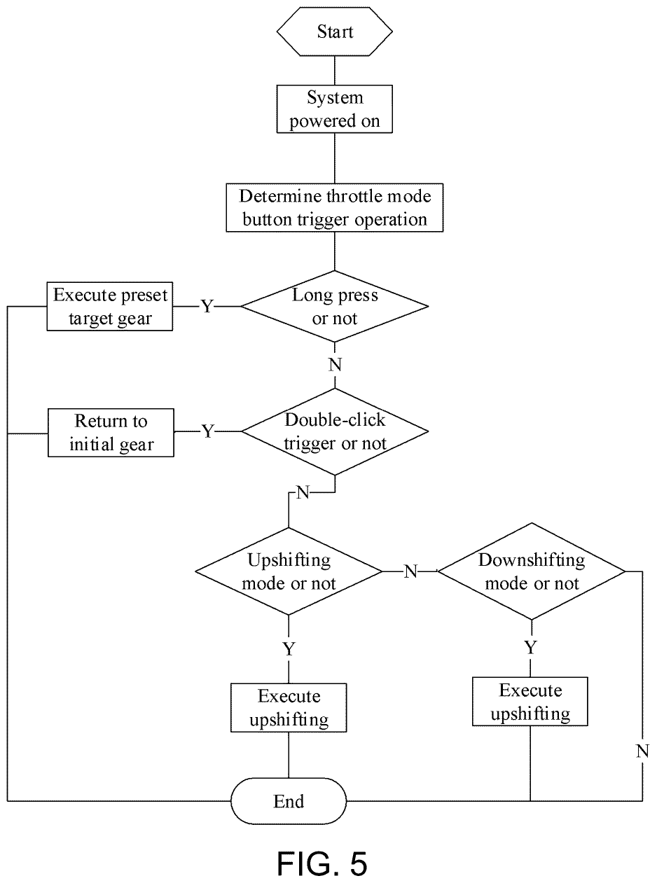

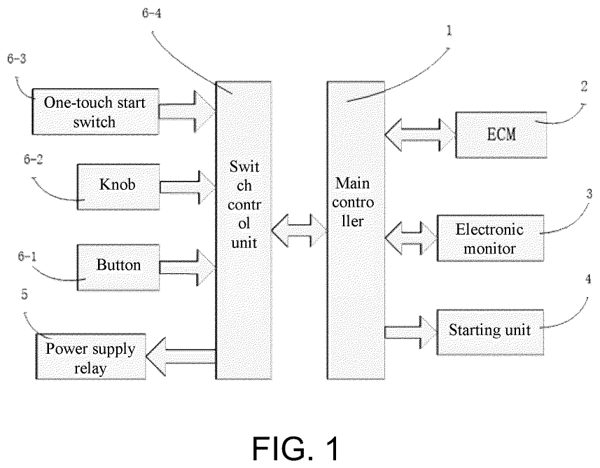

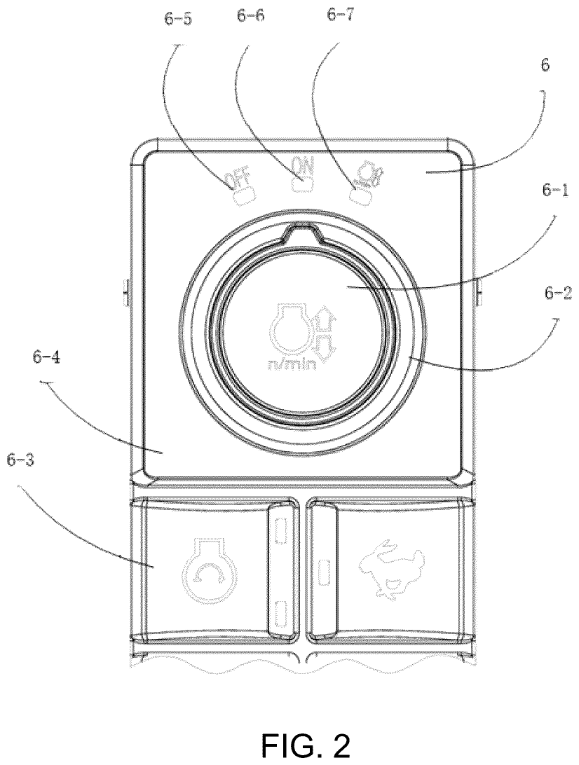

This embodiment provides an excavator throttle control device, referring to FIG. 1, comprising a main controller 1, an ECM 2, an electronic monitor 3, a starting unit 4, a power supply relay 5 and an integrated switch panel 6 (referring to FIG. 2).

Specifically, the main controller 1 and the ECM 2 are interconnected through a bus, the electronic monitor 3 and the main controller 1 are connected through a bus, the power supply relay 5 is electrically connected with the integrated switch panel 6, and the starting unit 4 is electrically connected with the main controller 1.

Referring to FIG. 1, the integrated switch panel 6 at least comprises a switch control unit 6-4 and three operational switches: a button 6-1, a knob 6-2, and a one-touch start switch 6-3, and the main controller 1 is connected with the switch control unit 6-4.

Referring to FIG. 2, the button 6-1 is used to control throttle modes. Specifically, the button 6-1 has a long press mode, a double-click mode and a single-click mode; in the long press mode, the switch control unit 6-4 sends an instruction for executing a preset target gear to the main controller 1, and the main control 1 determines an engine speed according to the instruction and sends the same to the ECM to make the engine execute a speed of the corresponding gear; in the double-click mode, the switch control unit 6-4 sends an instruction for executing a lowest gear to the main controller 1, and the main control 1 determines an engine speed according to the instruction and sends the same to the ECM to make the engine execute a speed of the corresponding gear; and in the single-click mode, alternating between upshifting and downshifting occurs with each press, and the switch control unit 6-4 sends a gear switching instruction to the main controller 1. The target gear and the lowest gear may be flexibly set through the electronic monitor.

The knob 6-2 is used to control the power supply and reset of the excavator engine. At the start, the knob is in an initial state, with an indicator light 6-5 lit, and the engine is powered off. Turning the knob 6-2 to a first gear causes the power supply relay 5 to be powered to engage to control the engine to be powered on, at which point an indicator light 6-6 is lit. Turning the knob 6-2 to a second gear allows for changing the throttle gear in the single-click mode. In the single-click mode, when the knob 6-2 is set to the second gear, each press of the knob 6-2 changes the gear state, enabling stepwise upshifting or downshifting. The switch control unit 6-4 sends an instruction for upshifting or downshifting to the main controller 1, and the main control 1 determines an engine speed according to the instruction and sends the same to the ECM to make the engine execute a speed of the corresponding gear.

It should be noted that single-click gear settings can be easily adjusted via the electronic monitor.

The one-touch start switch 6-3 is used to control the engine to start.

The switch control unit 6-4 is used to transmit control instructions of each operational switch to the main controller.

As a preferred embodiment, the button 6-1 may be an electronic switch button (self-reset button), or a touch screen button.

As a preferred embodiment, the knob 6-2 is a two-gear knob, where the first gear is self-locking and the second gear is reset.

Referring to FIG. 2, the integrated switch panel 6 further integrates a knob initial gear indicator light 6-5, a knob first gear indicator light 6-6 and a knob second gear indicator light 6-7 to indicate a current gear of the knob 6-2.

In this embodiment, the main controller is used to determine the engine speed according to a gear control signal sent by the switch control unit, and control the ECM to perform corresponding actions.

In this embodiment, the ECM is used to control the engine to execute a corresponding speed.

In this embodiment, the electronic monitor is used to record and set throttle gears. Specifically, whether to enable gear memory is set on the electronic monitor, and if the gear memory is enabled, the engine starts at the lowest gear speed and then returns to a last remembered speed. The target gear, lowest gear, highest gear and single-click gear speed may also be directly set on the electronic monitor.

In this embodiment, the starting unit is used to control the startup of an excavator system.

In this embodiment, the power supply relay is used to power on the excavator engine.

In this embodiment, the integrated switch panel is used to control the throttle gear through operational switches and transmit the control signal to the main controller.

In this embodiment, an operator may return the knob 6-2 to the initial gear to power off and shut down the engine.

### Embodiment 2

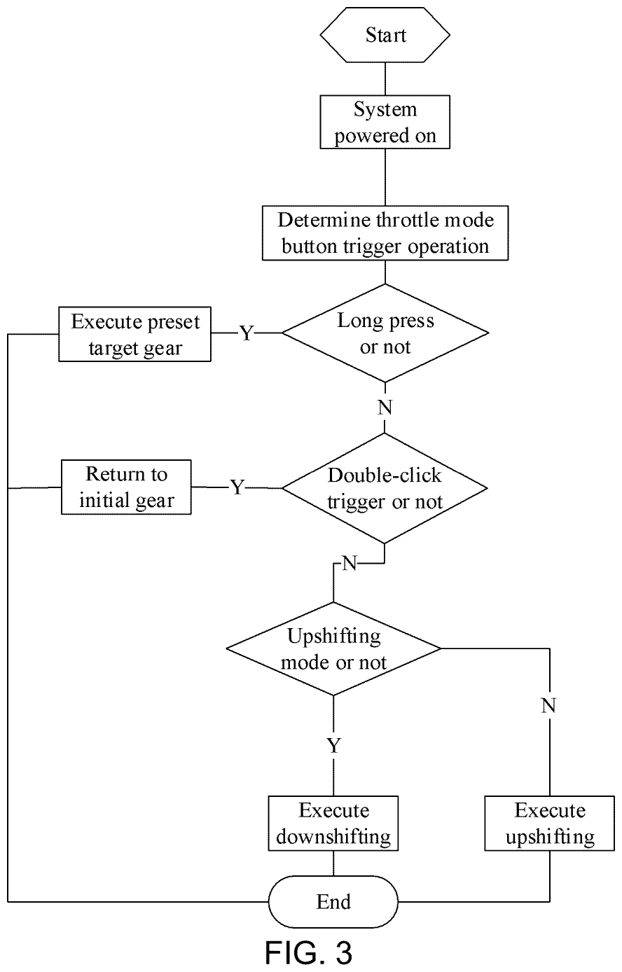

This embodiment provides an excavator throttle control method based on the excavator throttle control device of Embodiment 1, as shown in FIG. 3, comprising the following steps:

Step 1, turning the knob 6-2 on the integrated switch panel 6 to the first gear, so that the power supply relay 5 is powered to engage to control the engine to be powered on; controlling the engine to start through the one-touch start switch;

Step 2, determining whether poweroff gear memory is enabled, and if so, controlling the ECM through the main controller to make the engine execute a last gear speed prior to poweroff, an operator being able to set whether to enable the poweroff gear memory on the electronic monitor;

Step 3, if the poweroff gear memory is not enabled, checking the mode of the throttle mode button 6-1 on the integrated switch panel 6;
in response to the long press mode, controlling the ECM through the main controller to make the engine execute a preset target gear speed; and
in response to the double-click mode, controlling the ECM through the main controller to make the engine execute a preset lowest gear speed.

During operation, if the mode of the button 6-1 is switched to the single-click mode and the knob 6-2 is switched to the second gear, whether it is an upshift mode or a downshift mode is determined through the main controller; the gear state is changed with each press of the knob 6-2, that is, in the upshift mode, the gears increase progressively, and in the downshift mode, the gears decrease progressively; and the main controller controls the ECM to make the engine execute the corresponding gear speed.

It should be noted that after the engine starts, it is controlled to reach the target gear speed at a certain slope.

It should be noted that the knob may return to the initial gear to power off and shut down the engine.

### Embodiment 3

This embodiment provides an excavator throttle control device, the overall structure of which is the excavator throttle control device in Embodiment 1 shown in FIG. 1, comprising a main controller 1, an ECM 2, an electronic monitor 3, a starting unit 4, a power supply relay 5 and an integrated switch panel 6. The main controller 1 and the ECM 2 are interconnected through a bus, the electronic monitor 3 and the main controller 1 are connected through a bus, the power supply relay 5 is electrically connected with the integrated switch panel 6, and the starting unit 4 is electrically connected with the main controller 1.

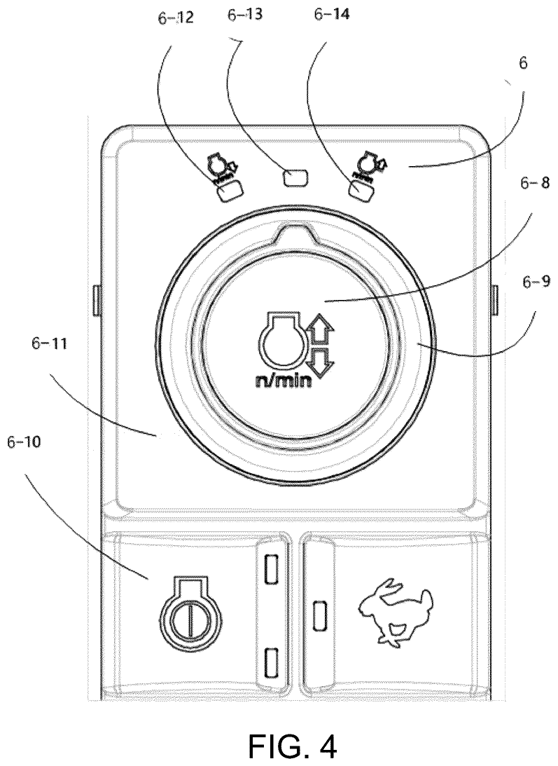

Referring to FIG. 4, in this embodiment, the integrated switch panel 6 at least comprises a switch control unit 6-11 and three operational switches: a button 6-8, a knob 6-9, and a one-touch start switch 6-10, and the main controller 1 is connected with the switch control unit 6-11.

The button 6-8 is used to control throttle modes. Specifically, the button 6-8 has a long press mode and a double-click mode; in the long press mode, the switch control unit 6-11 sends an instruction for executing a preset target gear to the main controller 1, and the main control 1 determines an engine speed according to the instruction and sends the same to the ECM to make the engine execute a speed of the corresponding gear; in the double-click mode, the switch control unit 6-11 sends an instruction for executing a lowest gear to the main controller 1, and the main control 1 determines an engine speed according to the instruction and sends the same to the ECM to make the engine execute a speed of the corresponding gear.

The knob 6-9 is used to control throttle gears.

Specifically, the knob 6-2 is a two-gear knob, with a middle position representing the initial gear, where an indicator light 6-13 is on; clockwise rotation corresponds to throttle increase, with an indicator light 6-14 lit; counterclockwise rotation corresponds to throttle decrease, with an indicator light 6-12 lit. Both gears feature a reset function.

Further, the knob has contact modes, comprising a short contact mode and a long contact mode;
in the short contact mode, when in a throttle increase mode, each contact causes the switch control unit 6-11 to send an instruction for increasing the gear by one to the main controller 1; when in a throttle decrease mode, each contact causes the switch control unit 6-11 to send an instruction for decreasing the gear by one to the main controller 1.

In the long contact mode, when in the throttle increase mode, a long contact causes the switch control unit 6-11 to send an instruction for executing the highest gear to the main controller 1; when in the throttle decrease mode, a long contact causes the switch control unit 6-11 to send an instruction for executing the lowest gear to the main controller 1.

It should be noted that if contact time is less than a preset duration, it is deemed a short contact; and if the contact time is greater than the preset duration, it is considered a long contact.

The one-touch start switch 6-10 is used to control the excavator engine to be powered on and started.

Specifically, the one-touch start switch 6-10 has a single-click mode and a long press mode. In the single-click mode, each press results in the engine being powered on, started, and shut down in sequence. For example, when the one-touch start switch 6-10 is pressed, the power supply relay 5 is powered to engage, and power is maintained through a retention circuit, enabling the excavator engine to be powered on; pressing the one-touch start switch 6-10 again controls the engine startup; pressing the one-touch start switch 6-10 again causes the engine to shut down immediately; and in the long press mode, the engine may be powered off and shut down with a delay.

The switch control unit 6-11 is used to send control instructions of the three operational switches to the main controller 1.

As a preferred embodiment, the button 6-8 may be an electronic switch button (self-reset button), or a touch screen button.

As a preferred embodiment, the integrated switch panel also integrates a throttle decrease indicator light 6-12, an initial gear indicator light 6-13, and a throttle increase indicator light 6-14 to indicate the status of the knob.

In this embodiment, the functions of the main controller, the ECM, the electronic monitor, the starting unit and the power supply relay are the same as those in Embodiment 1, and will not be repeated here.

It should be noted that the knob 6-2 may return to the initial gear to power off and shut down the engine.

### Embodiment 4

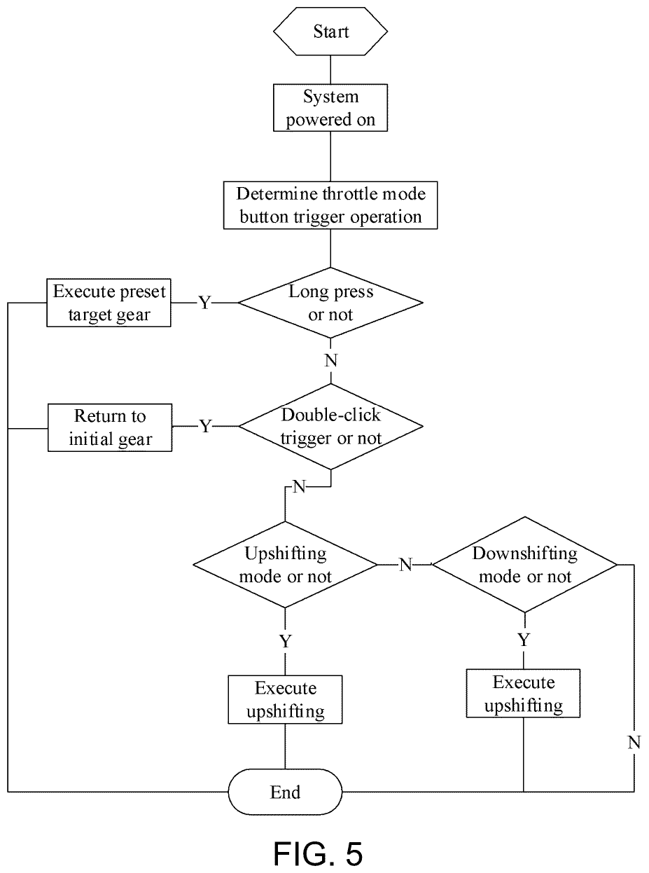

This embodiment provides an excavator throttle control method based on the excavator throttle control device of Embodiment 3, as shown in FIG. 5, comprising the following steps:

Step 1, pressing the one-touch start switch 6-10 on the integrated switch panel 6, so that the power supply relay 5 is powered to engage, and power is maintained through a retention circuit, enabling the excavator engine to be powered on; pressing the one-touch start switch 6-10 again to start the engine;

Step 2, determining whether poweroff gear memory is enabled, and if so, controlling the ECM through the main controller to make the engine execute a last gear speed prior to poweroff, an operator being able to set whether to enable the poweroff gear memory on the electronic monitor;

Step 3, if the poweroff gear memory is not enabled, checking the status of the throttle mode button 6-8 on the integrated switch panel,
in response to the long press mode, controlling the ECM through the main controller to make the engine execute a preset target gear speed, this gear speed being able to be configured as a common speed in the electronic monitor 3, allowing the operator to easily reach their frequently used speed with a one-touch operation;
in response to the double-click mode, controlling the ECM through the main controller to make the engine execute a preset lowest gear speed.

Checking the gear state of the knob 6-9 on the integrated switch panel during operation,
in response to the throttle increase mode, determining the contact mode; in response to a short contact, sending an instruction for increasing the gear to the main controller, allowing the main controller to determine a new gear and a corresponding speed, and sending an instruction for executing the corresponding speed to the ECM to make the engine execute the corresponding speed; in response to a long contact, sending an instruction for adjusting to the highest gear to the main controller, allowing the main controller to determine a speed corresponding to the instruction, and sending an instruction for executing the corresponding speed to the ECM to make the engine execute the highest speed.

In response to the throttle decrease mode, determining the contact mode; in response to a short contact, sending an instruction for decreasing the gear to the main controller, allowing the main controller to determine a new gear and a corresponding speed, and sending an instruction for executing the corresponding speed to the ECM to make the engine execute the corresponding speed; in response to a long contact, sending an instruction for adjusting to the lowest gear to the main controller, allowing the main controller to determine a speed corresponding to the instruction, and sending an instruction for executing the corresponding speed to the ECM to make the engine execute the lowest speed.

It should be noted that after the engine starts, it is controlled to reach the target gear speed at a certain slope.

It should be noted that the engine may be shut down by long pressing the one-touch start switch 6-10. If the engine speed is above the first gear speed at shutdown, the system may be configured for a delayed shutdown, cutting off power only after the control system is in the first gear mode and the preset duration is reached.

The above are only preferred embodiments of the invention, and it should be pointed out that for those of ordinary skill in the art, without departing from the technical principle of the invention, several improvements and variations can be made, and these improvements and variations should also be considered within the scope of protection of the invention.

1. An excavator throttle control device, comprising a main controller, an engine control module (ECM), an electronic monitor, a starting unit, a power supply relay and an integrated switch panel;
wherein the main controller and the ECM are interconnected through a bus, the electronic monitor and the main controller are connected through a bus, the power supply relay is electrically connected with the integrated switch panel, and the starting unit is electrically connected with the main controller;
the main controller is used to determine an engine speed according to a gear control instruction sent by the integrated switch panel and send the same to the ECM; and acquire a speed for each gear through the electronic monitor;
the ECM is used to control an engine to execute a corresponding speed;
the electronic monitor records and sets throttle gears, comprising a highest gear, a lowest gear and a target gear;
the starting unit is used to control a startup of an excavator system;
the power supply relay is used to power on the engine of the excavator; and
the integrated switch panel is used to control the throttle gear through operational switches and transmit the control instruction to the main controller.

2. The excavator throttle control device according to claim 1, wherein the integrated switch panel at least comprises a switch control unit and three operational switches: a button, a knob, and a one-touch start switch, and the main controller is connected with the switch control unit;
the button is used to control throttle modes, comprising a long press mode, a double-click mode and a single-click mode;
the knob is used to control a power supply and reset of the engine of the excavator;
the one-touch start switch is used to control the engine of the excavator to start; and
the switch control unit is used to transmit control signals of each the operational switch to the main controller.

3. The excavator throttle control device according to claim 2, wherein
in the long press mode, the switch control unit sends an instruction for executing the preset target gear to the main controller;
in the double-click mode, the switch control unit sends an instruction for executing the lowest gear to the main controller; and
in the single-click mode, the switch control unit sends a gear switching instruction to the main controller, alternating between upshifting and downshifting with each press.

4. The excavator throttle control device according to claim 2, wherein the knob has an initial gear, a first gear and a second gear;
in the initial gear, the engine is in a reset state and is not powered on;
in the first gear, the power supply relay is powered to engage to control the engine of the excavator to be powered on;
the second gear is used to change the throttle gear;
in the single-click mode of the button, each press of the knob changes a gear state; if the current single-click mode is for upshifting, the switch control unit sends an instruction for increasing the gear by one to the main controller; and if the current single-click mode is for downshifting, the switch control unit sends an instruction for decreasing the gear by one to the main controller.

5. The excavator throttle control device according to claim 4, wherein the integrated switch panel further integrates a knob initial gear indicator light, a knob first gear indicator light and a knob second gear indicator light to indicate a current gear of the knob.

6. The excavator throttle control device according to claim 1, wherein the integrated switch panel at least comprises a switch control unit and three operational switches: a button, a knob, and a one-touch start switch, and the main controller is connected with the switch control unit;
the button is used to control throttle modes, comprising a long press mode and a double-click mode;
the knob is used to control the throttle gears, comprising throttle increase and throttle decrease;
the one-touch start switch is used to control the engine of the excavator to be powered on, started and shut down; and
the switch control unit is used to transmit the control instructions of each the operational switch to the main controller.

7. The excavator throttle control device according to claim 6, wherein
in the long press mode, the switch control unit sends an instruction for executing the preset target gear to the main controller; and
in the double-click mode, the switch control unit sends an instruction for executing the lowest gear to the main controller.

8. The excavator throttle control device according to claim 6, wherein a middle position of the knob is an initial gear, with clockwise rotation for throttle increase and counterclockwise rotation for throttle decrease, and both gears feature a reset function;
the knob has contact modes, comprising a short contact mode and a long contact mode;
in the short contact mode, when in a throttle increase mode, each contact causes the switch control unit to send an instruction for increasing the gear by one to the main controller; when in a throttle decrease mode, each contact causes the switch control unit to send an instruction for decreasing the gear by one to the main controller;
in the long contact mode, when in the throttle increase mode, a long contact causes the switch control unit to send an instruction for executing the highest gear to the main controller; when in the throttle decrease mode, the long contact causes the switch control unit to send an instruction for executing the lowest gear to the main controller;
if contact time is less than a preset duration, it is deemed a short contact; and if the contact time is greater than the preset duration, it is considered the long contact.

9. The excavator throttle control device according to claim 6, wherein the one-touch start switch has a single-click mode and the long press mode;
in the single-click mode, each press results in the engine being powered on, started, and shut down in sequence; and
in the long press mode, the engine is powered off and shut down with a delay.

10. The excavator throttle control device according to claim 2, wherein the button is an electronic switch button or a touch screen button.

11. The excavator throttle control device according to claim 2, wherein the electronic monitor is specifically used to,
determine whether to enable gear memory, if the gear memory is enabled, the engine starts at the lowest gear speed and reaches a last remembered speed;
and,
set the target gear, the lowest gear, the highest gear and a single-click gear.

12. An excavator throttle control method, comprising:
turning the knob on the integrated switch panel in the excavator throttle control device according to claim 2 to a first gear, so that the power supply relay is powered to engage to control the engine to be powered on; controlling the engine to start through the one-touch start switch on the integrated switch panel;
determining whether poweroff gear memory is enabled, and if so, controlling the ECM through the main controller to make the engine execute a last gear speed prior to poweroff;
if the poweroff gear memory is not enabled, checking the mode of the button on the integrated switch panel;
in response to the long press mode, controlling the ECM through the main controller to make the engine execute a preset target gear speed;
in response to the double-click mode, controlling the ECM through the main controller to make the engine execute a preset lowest gear speed;
in response to the single-click mode, determining, through the main controller, whether to upshift or downshift; at the same time, changing a gear state with each press of the knob, that is, in the upshift mode, the gears increase progressively, and in a downshift mode, the gears decrease progressively; and determining, through the main controller, the changed gear and the corresponding speed, and controlling the ECM to make the engine execute a corresponding gear speed.

13. An excavator throttle control method, comprising:
pressing the one-touch start switch on the integrated switch panel in the excavator throttle control device according to claim 6, so that the power supply relay is powered to engage to control the engine to be powered on; pressing the one-touch start switch again to start the engine;
determining whether poweroff gear memory is enabled, and if so, controlling the ECM through the main controller to make the engine execute a last gear speed prior to poweroff;
if the poweroff gear memory is not enabled, checking the mode of the button on the integrated switch panel;
in response to the long press mode, controlling the ECM through the main controller to make the engine execute a preset target gear speed;
in response to the double-click mode, controlling the ECM through the main controller to make the engine execute a preset lowest gear speed;
checking a gear state of the knob on the integrated switch panel;
in response to a throttle increase mode, determining a contact mode; in response to a short contact, sending an instruction for increasing the gear to the main controller, allowing the main controller to determine a new gear and a corresponding speed, and sending an instruction for executing the corresponding speed to the ECM to make the engine execute the corresponding speed; in response to a long contact, sending an instruction for adjusting to the highest gear to the main controller, allowing the main controller to determine a speed corresponding to the instruction, and sending an instruction for executing the corresponding speed to the ECM to make the engine execute a highest speed;
in response to a throttle decrease mode, determining the contact mode; in response to the short contact, sending an instruction for decreasing the gear to the main controller, allowing the main controller to determine a new gear and a corresponding speed, and sending an instruction for executing the corresponding speed to the ECM to make the engine execute the corresponding speed; in response to the long contact, sending an instruction for adjusting to the lowest gear to the main controller, allowing the main controller to determine a speed corresponding to the instruction, and sending an instruction for executing the corresponding speed to the ECM to make the engine execute a lowest speed;
if contact time is less than a preset duration, it is deemed the short contact; and if the contact time is greater than the preset duration, it is considered the long contact.

14. The excavator throttle control device according to claim 6, wherein the button is an electronic switch button or a touch screen button.

15. The excavator throttle control device according to claim 6, wherein the electronic monitor is specifically used to,
determine whether to enable gear memory, if the gear memory is enabled, the engine starts at the lowest gear speed and reaches a last remembered speed;
and,
set the target gear, the lowest gear, the highest gear and a single-click gear.
